(19) United States
(12) Patent Application Publication
(10) Pub. No.: US 2021/0222412 A1
(43) Pub. Date: Jul. 22, 2021

(54) DRAIN AUGER MACHINE ATTACHMENT FOR UNCLOGGING DRAINS

(71) Applicant: David EMSLIE, Calgary (CA)

(72) Inventor: David EMSLIE, Calgary (CA)

(21) Appl. No.: 16/963,004

(22) PCT Filed: Aug. 24, 2018
(86) PCT No.: PCT/CA2018/051023

§ 371 Date: Jul. 17, 2020

(30) Foreign Application Priority Data
Aug. 25, 2017 (CA) 2,978,115

(51) Int. Cl. E03C 1/302; E03C 1/304; B08B 9/045; B08B 13/00

(52) U.S. Cl. CPC E03C 1/302; E03C 1/304; B08B 2209/032; B08B 13/00; B08B 2209/04; B08B 9/045

(57) ABSTRACT

An apparatus configured for attachment to an auger machine and a drain pipe that encloses an auger and its cable to prevent particulate matter, liquids and other materials of the drainpipe from splattering the environment outside of the drainpipe. The apparatus can include a camera tube for receiving a camera that is inserted into the apparatus and into the drainpipe for visual inspection of the drainpipe. The apparatus can include a water inlet that receives a pressurized source of water for rinsing the camera and its cable while it is retracted, for removing any attached particulate matter after the drain has been unclogged. Furthermore, the auger and its cable are also rinsed as it is being retracted from the drainpipe. An oil applicator positioned upstream of water inlet physically removes any left over particulate matter attached to the auger cable and oils the cable as it retracts into the auger machine.

### CROSS REFERENCE TO RELATED APPLICATIONS

This application claims the benefit of priority of Canadian patent application serial number 2978115 filed Aug. 25, 2017, which is hereby incorporated by reference.

### FIELD

The present disclosure relates generally to a device to aid in the process to unclog drains.

### BACKGROUND

Many inventions have been developed for plumbers and for various plumbing activities. With the increase in population worldwide and developing countries using increasing amounts of indoor plumbing there has never been a greater need to facilitate one of the most arduous tasks plumbers need to accomplish on a daily basis. While there are many tasks which a plumber are qualified to accomplish one of the most time consuming is the cleaning of drains and main sewer drains.

Drains can typically become clogged up for a variety of reasons: presence of hair, dental floss, toys or other solid objects food residues, tree roots, etc. A service plumber can typically have to deal with as many as 5 drains to be unclogged in a typical day. While unclogging a drain is typically routine for any service plumber, the removal of the snake and cleaning thereof always presents a certain challenge and is time consuming as it requires the plumber to spend an inordinate amount of time ensuring that the snake is carefully cleaned while being removed with substantial control in order to avoid creating a spillage of water and any other foreign material in the area close to the drain pipe access point. The removal of the snake can cause scattering of small particles on the walls and the floor, vanity or cabinets close to the drain pipe access point. This spraying and scattering caused by the returning spinning snake is often a dark intense smelling particles that requires immediate clean up or risks staining cabinetry or walls imparting a foul smell to the general area.

To the inventor's knowledge, no system or device has ever been designed to address this issue which would lead to substantial time savings to plumbers and lower costs to clients requiring the service of such.

According to the present invention, there is provided a system designed to substantially overcome the above mentioned problems and allow plumbers to dedicate more of their time to other plumbing tasks.

### SUMMARY

According to a first aspect of the present invention, there is provided a novel apparatus for use in unclogging drains, said apparatus comprises:

an auger;

a coiled flexible cable adapted to connect to said auger;

a sleeve defining an interior portion adapted to receive the auger and the coiled wire;

said sleeve comprising a first end and a second end; said first end comprising a leak proof attachment means adapted to securely attach to a drain access port; said second end having a sealing engagement with the coiled cable and connected to said sleeve.

In one embodiment, the apparatus further comprises a fluid injection port located on said sleeve located on the sleeve between the first and the second end and adapted to permit fluid injection into the sleeve towards said first end; said fluid injection port adapted to allow injection of fluid when in use and a seal against fluid leakage when not in use. According to another embodiment, the auger is connected to a manual auger feed. According to another embodiment, the auger is connected to an electric auger self-feeding machine.

The apparatus can include an access port to allow a cabled inspection camera to be introduced into said sleeve.

The apparatus can include a valve located proximate the injection port, said valve adapted to allow a user to control the volume of fluid being injected into said sleeve.

Furthermore, the apparatus can include an adaptive sleeve located at said second end of the sleeve for connection with a manual auger or electric auger self-feeding machine.

According to a first aspect of the present invention, there is provided a sleeve for use with a coiled cable for unclogging a drain, said sleeve defining an interior portion adapted to receive an auger and said coiled cable; said sleeve comprising a first end and a second end; said first end comprising a leak proof attachment means adapted to securely attach to a drain access port; said second end having a sealing engagement with the coiled cable and connected to said sleeve.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a side view of the sleeve according to a present embodiment;

FIG. 2 is a close-up side view of the first end of the sleeve according to a present embodiment;

FIG. 3 is a close-up side view of the second end of the sleeve according to a present embodiment;

FIG. 4 is an exploded view of the sleeve according to an alternate embodiment;

FIG. 5 is a plan view drawing of the oil applicator shown in FIG. 4;

FIG. 6 is a top down view of a main body of the sleeve, according to a present embodiment; and

FIGS. 7A and 7B show a top down view of a portion of the sleeve with the oil canister attached to the main body.

### DETAILED DESCRIPTION

According to an embodiment of the present invention, the system to unclog drains would be safer in use by the operator; it would keep operator clean; it would also minimize or completely eliminate reel twisting of an auger cable; it would substantially reduce messes and the time for clean up such messes caused by the removal of the coiled wire from the drain pipe. According to another embodiment, the system would also help purge the pipe with water while the auger cable is still present in the drain pipe. According to yet another embodiment, one could also insert a cable camera into the sleeve of the system to perform a visual inspection prior to removal of the coiled wire from the drain pipe to ensure completion of the operation.

If neither cleaning the trap nor plunging the trap clears a plumbing clog, one must resort to using a drain auger (also known as a snake). Snakes have proven their worth over the years as they are capable of reaching clogs located deep within a drainpipe. This tool, is a coiled metal spiral snake approximately ¼-inch thick (on average) comprises a handle (for manual operation) on one end or an electric motor to spin the cable. One feeds the coiled cable until it reaches the clog at which point the coiled metal spiral snake is rotated to push it farther down the drain and to loosen up and break up the clog. Generally some parts of the clog will break off and be flushed down the drain. The snake also allows one to retrieve the clog from the area it obstructs and can be pulled up and out completely from the drain pipe. Some snakes are made to be attached onto an electric drill. This allows the snake to be rotated at a much higher speed which in turn can provide more power to unclog drainpipes.

The method of using the apparatus according to an embodiment of the present invention comprises the following steps:

connecting the sleeve to a drain access port by securing the attachment means to the drain access port;
inserting the auger and coiled cable into the sleeve and drain access port; securing the second end of the sleeve around the coiled cable to ensure minimal leakage of fluid from the sleeve;
feeding the coiled cable down the drain pipe until resistance is encountered; rotating the auger against the blockage until the resistance has been eliminated and the coiled cable can be fed deeper down the drain without resistance; pull the coiled cable back to remove it from the drain pipe;
optionally, water can be injected into the sleeve to further help in clearing up the clog but to also clean the coiled cable and auger prior to removal from the sleeve; once the coiled cable and auger are removed from the drain pipe, the attachment means can be removed from the drain access port;
optionally, the seal placed on the second end of the sleeve may be removed to completely remove the coiled cable from the sleeve.

It is the rotating action of the auger which allows the end of the snake to attach to the clog and spin it away or break it up. If the clog is a solid object, the auger head will most likely grasp the object. If the auger doesn't seem to be breaking through the clog but the twisting is progressively easier, one should pull the auger out of the drain, this would, in a great number of circumstances, remove the encumbrance from the pipe. However, ideally water should be injected into the sleeve attached to the drain access point to ensure that the drain is unclogged and at the same time rinse out the object and the auger snake as it spins. Running the water down the pipe while the auger remains in the pipe allows the clog to be washed away and permits a primary step of cleaning the auger prior to its removal from the drain. By allowing the water to be continuously run while the auger is being removed from the drain allows to clean the auger and ensure it continues to be cleaned until it has been completely removed from the drain. Once the auger has been fully retracted and is back in the drum the water may be run in order to clean the sleeve prior to its disconnection and removal from the drain attachment. According to an embodiment of the present invention, the coiled flexible cable adapted to connect to said auger is adapted to attach different types of cutting heads depending on circumstances or requirements.

According to a present embodiment, the sleeve may be made of flexible material. According to another embodiment, the sleeve may be made of semi-flexible material. According to yet another alternative embodiment, the sleeve may be made of substantially rigid material. The sleeve can be made of transparent (or see through) material to provide the user with a visual indication of the cleanliness of the coiled cable upon removal from the drain pipe.

The drain access port attachment means can include any plumbing component or material adapted to operatively connect to said port and provide a substantially sealing attachment. The attachment means can include a threaded portion adapted to be inserted and threaded onto the drain access port.

The second end of the sleeve can include a removable sealing component adapted to frictionally fit around the coiled cable in order to minimize any leakage or fluid loss from the second end of the sleeve by minimizing the gap between the sleeve and the coiled cable. This may be accomplished by using a rubber gasket adapted to fit around the coiled cable and sealingly engage the sleeve. Of course, any material conveying the same function and quality are to be considered within the scope of the description. Any material, attachment or seal known to the person skilled in the art are to be considered within the description of sealing means located at the second end of the sleeve.

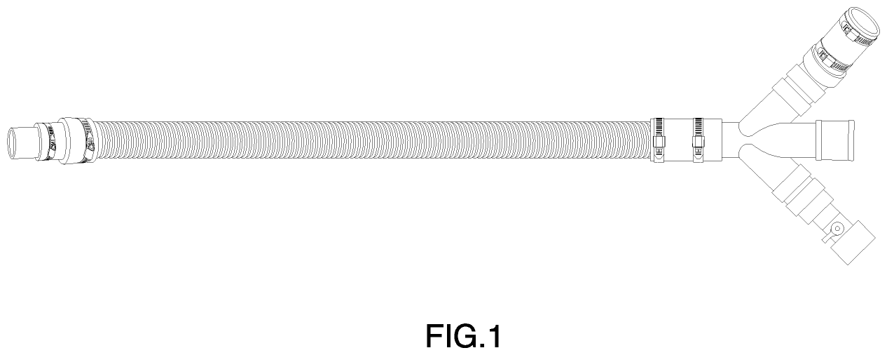

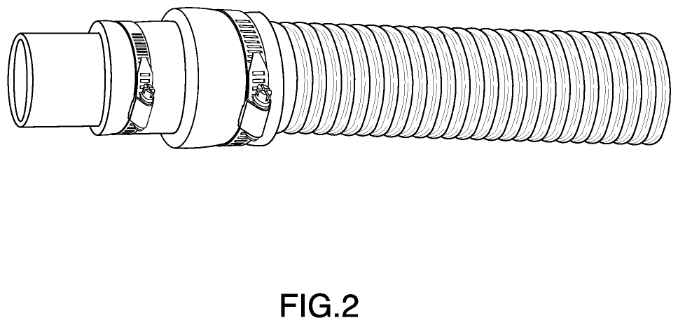

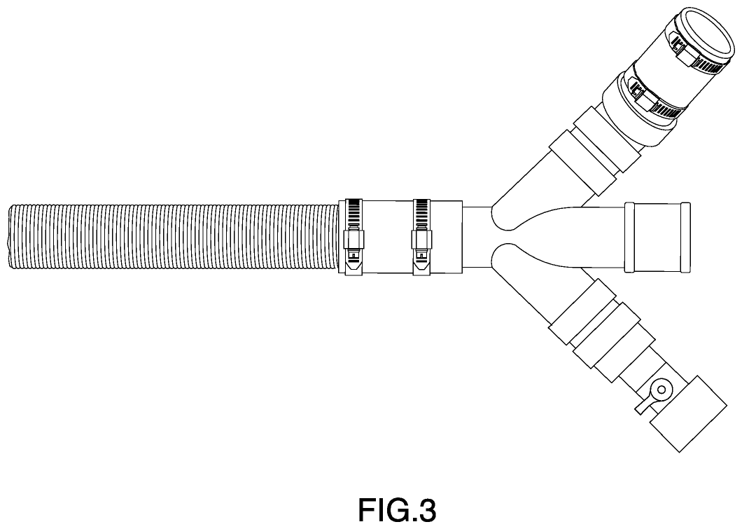

In the previously shown embodiments of FIGS. 1-3, the sleeve can be assembled as a single unit were various parts may be rotatable relative to each other to allow connection of one end of the sleeve to a threaded drain access port and connection of the other end of the sleeve to an auger machine. It should be noted that the drain access port is also referred to as a drain clean out.

If the auger machine does not have a threaded portion, then the other end of the sleeve can be configured for a friction fit, or with some type of clamping mechanism, to secure it to the auger machine such that it does not separate from the auger machine during normal use.

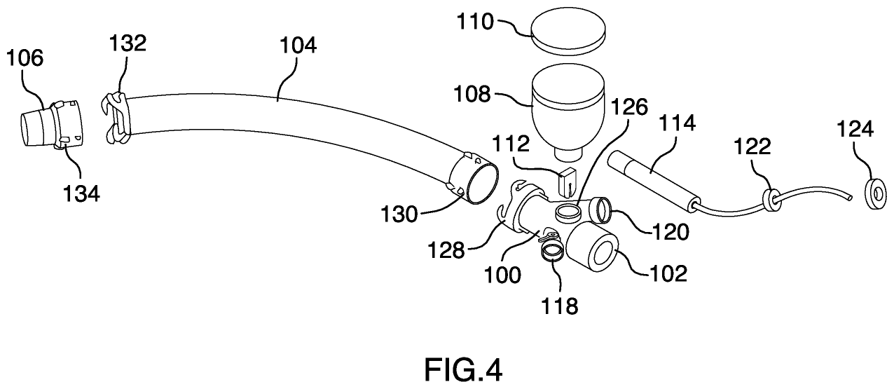

An alternate embodiment of the sleeve is shown in FIG. 4 that shows further details of the sleeve of the embodiment of FIGS. 1-3. This alternate embodiment of FIG. 4 achieves at least the same advantages and functionality as the sleeve of the embodiment of FIGS. 1-3, namely encapsulating the auger and its coiled cable between a drain access port and the auger machine.

The sleeve embodiment of FIG. 4 includes a rigid main body 100, an auger machine adapter 102, a flexible hose 104, and a cleanout adapter 106. Optional components which are discussed later include a generally cone-shaped oil canister 108, oil canister lid 110, oil applicator 112, camera 114, and a water hose (not shown).

The main body 100 is hollow, cylindrical in shape and constructed of any material that maintains rigidity and does not flex. An upstream end of the main body 100 is configured to receive the auger machine adapter 102. By example, the auger machine adapter 102 and the end of the main body 100 are in threaded engagement with each other so that an operator simply screws on the appropriate auger machine adapter 102. Different auger machine adapters 102 of different sizes can be constructed to adapt to auger machines of different sizes, makes and models. In one example, the auger machine adapter 102 can be configured to connect to the K-6200 drum machine manufactured by RIDGID™ Tools. Once the appropriate auger machine adapter 102 has been attached onto the main body 100, the main body with attached auger machine adapter 102 is attached to the auger machine. Both the main body 100 and the auger machine adapter 102 are sized to allow an auger and cable to slide through without significant resistance.

Various coupling mechanisms can be used to attach the auger machine adapter 102 to the main body 100, and to attach the auger machine adapter 102 to the auger machine. By example, a friction fit, quick release, gear clamps, bayonet mount, bolted Allen key and other such mechanical coupling systems can be used provided that the main body remains fixed and unmovable relative to the auger machine when it is attached thereto.

It is noted that “upstream” refers to a position closer to the auger machine and away from the drain pipe, whereas “downstream” refers to a position further away from the auger machine and generally the direction where water flows down and open drain.

According to an alternate embodiment, a removable rigid extension tube (not shown) can be attached to the upstream end of the main body 100, which itself can have an upstream and configured to receive the auger machine adapter 102. This provides additional clearance of the main body 100 from the auger machine if required.

Extending at an angle from the main body 100 is a water supply hose attachment 118 with an integrated volume control shutoff switch and/or valve, the mechanisms of which is well known in the art. For example the volume control shutoff switch can electrically controlled using a low-voltage. The hose attachment 118 can be any standard sized threaded hose attachment, to which a pressurized water supply can be screwed on. For example, this can be a threaded male connector for receiving a typical female garden hose connector. Therefore the hose attachment 118 allows water from the pressurized water supply to enter the main body 100. Accordingly, the angled configuration of the hose attachment facilitates pressurized water to flow away from the auger machine adapter 102 to prevent water from splashing back towards the auger machine. Alternate to a municipal pressurized water supply, the water supply hose attachment 118 can be attached to a portable water supply that can be used to mechanically or manually pump water into the main body 100.

Also extending at an angle from the main body 100 is a camera access tube 120 that is sized to receive camera 114. Once inserted, the camera 114 can be pushed through the main body 100 and beyond, eventually into the drain pipe to which the sleeve is connected to for the purposes of inspecting any blockage in the drain pipe. A split washer 122 with a hole in the center can be placed over the cable of the camera 114, and is seated in the opening of the camera access tube 120 when the camera is inserted into the camera access tube 120. Finally, a cap 124 with a hole to allow the camera cable to slide through is secured onto the hole of the camera access tube 120 to prevent the split washer 122 from falling out as the camera cable is retracted. The split washer 122 is intended to scrape off as much matter and liquid as possible from the camera cable, as the camera cable is retracted. This helps clean the cable and minimizes cleanup time by the operator. The split washer 122 also prevents water from the water supply hose attachment 118 from splashing out of the sleeve as it is sized to cover the hole of camera access tube 120. A different type of cap similar to that of cap 124 but without a hole can be used to cover the camera access tube 120 when no camera 114 is being used for this same purpose. The camera access tube 120 is angled to direct or guide insertion of the camera 114 towards the drain access port, and away from the auger machine.

Extending perpendicular to the main body 100 is an oil inlet 126 that is circular in shape. Within the oil inlet 126 is an inlet aperture (not shown) shaped to receive the oil applicator 112. This means that the dimensions of the inlet aperture are slightly larger than the dimensions of the oil applicator 112. For example, if the inlet aperture is rectangular in shape, then the oil applicator 112 also has a similar rectangular shape, but just smaller in size to allow a trickle of oil enter the inlet aperture while the oil applicator 112 is inserted therein. After the oil applicator 112 has been inserted into the inlet aperture of the oil inlet 126, the oil canister 108 is slid onto the oil inlet 126. The oil inlet 126 and the neck of the oil canister 108 are configured to engage with each other such that the oil canister 108 can rotate about an axis extending from the oil inlet 126. The neck of the oil canister 108 and the oil inlet 126 cooperate to form a valve to release oil stored in the oil canister 108 onto the inlet aperture with inserted while applicator 112. Further details of this valve system is described later. The oil canister lid 110 is used to cover the open end of oil canister 108 to prevent spillage. As use of the oil canister 108 is optional, a cap is provided to cover over oil inlet 126 to prevent water provided via water supply hose attachment 118 from splashing out of the main body 100.

It should be noted that the oil inlet 126 has a center that is aligned with the long axis of the main body 100, and is positioned closer to the auger machine adapter 102 and upstream of the position within the main body where the water from the water supply hose attachment 118 enters the main body 100. The oil inlet 126 is also positioned upstream of the position within the main body 100 where the camera enters the main body 100. Furthermore, because the oil is fed by gravity, the main body 100 is attached with an orientation where the oil canister 108 remains substantially upright. If the oil canister 108 is not used, then the orientation of the main body 100 does not matter.

The opposite end of the main body 100 is configured to have a female connector 128 that is rotatable about the circumference of the main body 100, for attachment and locking to a corresponding male connector of the hose 104. This opposite end of the main body 100 can be referred to as the downstream end of main body 100

Hose 104 is formed of a flexible material to allow the hose to bend in any direction. The upstream end of hose 104 includes a male connector 130 configured to mate with female connector 128. The male connector 130 is fixed in place to the end of hose 104 and does not rotate or shift. In other words, the male connector 130 is insertable into female connector 128, after which the female connector 128 can be rotated or twisted in a clockwise direction where resilient hooks engage with protrusions on the surface of the male connector 130 to lock both the connectors in place. An alternate configuration includes a bayonet style twist connection system. Connection mechanisms such as this are well known in the art and do not need to be described in any further detail. The downstream end of hose 104 has a female connector 132, which can be identical in configuration to female connector 128, that rotates about the circumference of the hose 104. The hose 104 can be of any length. In alternate embodiments, multiple hoses 104 of the same length can be attached to each other to extend the overall length. It is a simple matter of attaching the male connector 130 of a first hose to the female connector 132 of a second hose, and then attaching the male connector 130 of the second hose to the female connector 128 of the main body 100.

In any embodiment, the female connector 132 is attachable to a male connector 134 positioned at the upstream end of the cleanout adapter 106. The downstream end of the cleanout adapter 106 can be threaded and sized to screw into a drain access port having a known size. Cleanout adapters 106 having different downstream sizes can be used with different plumbing drainage sizes.

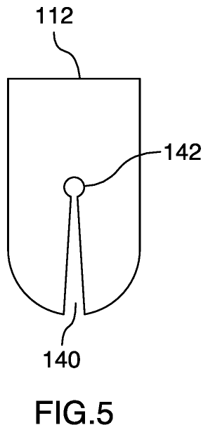

A further discussion of the oil applicator 112 is now described with reference to FIG. 5. FIG. 5 is a drawing of the oil applicator 112 shown in FIG. 4. The rounded bottom end of the oil applicator 112 is to be inserted into the inlet aperture of the oil inlet 126 while the flat top end of the oil applicator 112 remains within the same inlet aperture. Extending from a central area of the rounded bottom and is a slit that extends toward the top end, and ends in an auger hole 142. The oil applicator 112 has a predetermined thickness, and both the slit 140 and the auger hole 142 extend through the entire predetermined thickness. The slit 140 can be generally V-shaped such that it has a larger opening at the rounded end of the oil applicator 112 then at the auger hole 142. Assuming the auger has been inserted into the main body 100, the previously described alignment of the oil inlet 126 enables the slit 140 to receive the auger cable.

The wider opening of slit 140 facilitates entry of the cable into the slit 140. Eventually the oil applicator 112 cannot descend any further into the main body 100 when the cable is received in the auger hole 142. Accordingly, the distance between the auger hole 142 and the top of oil applicator 112 is preset based on where the auger cable should be situated. Because the auger cable is flexible and the oil applicator 112 is fixed in its position, the bottom end of the oil applicator 112 can be configured with a wider groove to help guide the cable towards the narrowing slit 140 if the position of the cable is laterally offset from the central axis of main body 100. It is noted that the auger cable generally remains centrally positioned within the main body as it exits the auger machine. The oil applicator 112 can be made of a foam material or some other porous material that allows oil to flow slowly through it.

According to an alternate embodiment, the oil applicator 112 includes two individual oil applicators that are both inserted into the oil inlet 126 such that both auger holes 142 receives the auger cable. Each oil applicator would be the same as shown in FIG. 5 except it would be thinner than a unitary one that fits in the same sized oil inlet 126. In this alternate embodiment, the oil inlet 126 is configured to include a physical separator to maintain a small gap between the inserted oil applicator pieces, thereby allowing some oil to flow between them and onto the auger cable. In a further alternate embodiment, the single unitary oil applicator 112 can include preformed channels therein to guide oil to the cable seated in the auger hole 142. Any suitable configuration for the oil applicator 112 that provides oil to the cable can be used.

In both described embodiments, the oil applicator slit 140 will close up as the auger hole is biased against the auger cable.

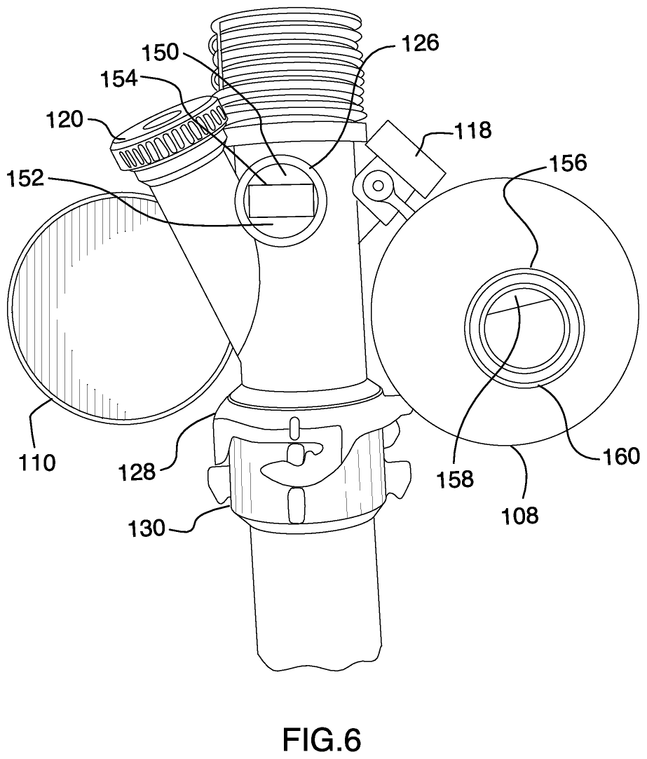

FIG. 6 is a top down view of a main body shown in FIG. 4, which shows additional details of the oil canister 108 and the oil inlet 126. In FIG. 6, the shown orientation would be the installed orientation of the main body 100 relative to ground with an auger machine. The oil canister 108 is shown upside down such that the bottom of its neck is viewable. The same numbered elements have been previously described with respect to the embodiment of FIG. 4.

As shown in FIG. 6, oil inlet 126 includes a raised circular sidewall of a predetermined thickness and height extending from the body 100. Inside of the oil inlet is a flat surface consisting of a first blocking surface 150 and a second blocking surface 152 coplanar with the first blocking surface 150. Both the first blocking surface 150 and a second blocking surface 152 are shaped as circular segments and positioned on opposite sides of the oil inlet 126 such that a gap is formed between their respective flat ends. This forms a generally rectangular shaped inlet aperture 154. The inlet aperture 154 extends into the body 100, for receiving the oil applicator 112 as previously described.

Now turning to the oil canister 108, the bottom end of the neck includes a cylindrical column 156 ending with a flat closed surface with the exception of an outlet aperture 158. This outlet aperture 158 extends into the reservoir portion of the oil canister 108, thereby allowing oil to flow out through the outlet aperture 158. In the present embodiment, the outlet aperture 158 is shaped as a circular segment that is equal to or smaller than both the first blocking surface 150 and a second blocking surface 152. The cylindrical column 156 is sized for a close fit within oil inlet 126, sufficient to prevent oil within oil canister 108 from leaking out while allowing the oil canister to turn under applied twisting force from an operator. To further secure the oil canister 108 in the oil inlet 126, a recessed groove 160 is provided around the circumference of the cylindrical column 156. This recessed groove 160 is sized for a close fit over the sidewall of the oil inlet 126. The first blocking surface 150, the second blocking surface 152, the inlet aperture 154 and the outlet aperture 158 form a valve

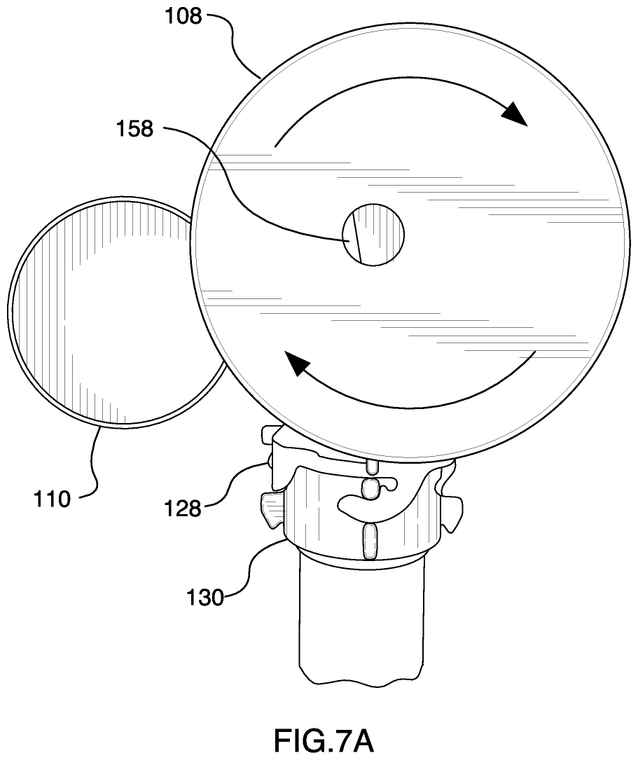

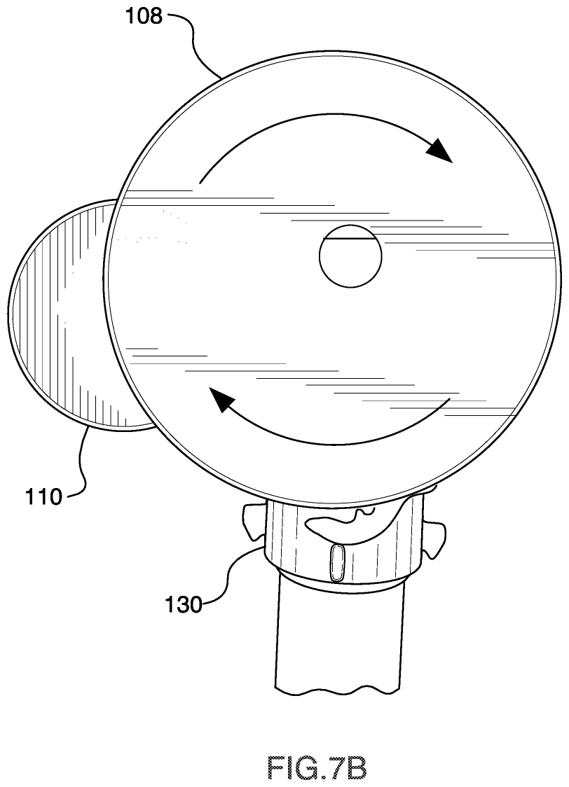

The valve operating functionality of the oil canister 108 with the oil inlet 126 is now described with reference to FIGS. 7A and 7B.

FIGS. 7A and 7B show a top down view of a portion of the sleeve with the oil canister 108 installed or slid onto on the oil inlet 126 of the main body 100. In the current view, the main body 100 is mostly obstructed from view. It is noted that this orientation would be the installed orientation of the main body 100 with an auger machine. It is assumed that during normal use, the oil applicator 112 has been inserted into the inlet aperture 154 and the oil canister 108 has been filled with oil. In the presently shown example operation, the oil is omitted and the oil canister lid 110 is removed to facilitate an explanation of the valve operation.

In FIG. 7A, the valve is in the open position because the outlet aperture 158 overlaps with the inlet aperture 154. Therefore oil flows from the oil canister 108 and into the oil applicator 112. To close the oil canister, the oil canister 108 is twisted clockwise such that the outlet aperture 158 is aligned or overlaps with the one of the blocking surfaces 150 or 152. The example of FIG. 7B shows an example where the outlet aperture 158 is aligned with the first blocking surface 150. Of course, the oil canister 108 can be rotated in the counterclockwise direction so that the outlet aperture 158 is aligned with the second blocking surface 152 instead. Therefore, the oil canister 108 can be rotated continuously in a clockwise direction or a counterclockwise direction to open and close the valve. Alternately, the oil canister 108 can be rotated clockwise to open the valve and then counterclockwise to close the valve, or vice versa. Because of the circular segment shape of the outlet aperture 158, the operator can control the amount of oil being released into the inlet aperture 154 by gradually turning the oil canister 108 to change the area of the outlet aperture 158 that overlaps with the inlet aperture 154.

The presently shown embodiments utilize a specific circular segment shapes for the blocking surfaces 150 and 152, and for the outlet aperture 158. In alternate embodiments, any combination of sizes and shapes of the blocking surfaces 150 and 152, and for the outlet aperture 158 can be used provided overlap of the outlet aperture 158 with one or more blocking surfaces restricts oil from flowing into the inlet aperture 154.

In further alternate embodiments, any type of mechanical valve system can be used to stop and start the flow of oil from the oil canister 108 to the inlet aperture 154.

A description of one way to execute a drain blockage removal operation using the sleeve shown in the embodiments of FIGS. 4-7B now follows with reference to the series of steps below. It is assumed that residential or commercial drainpipe is blocked and an auger machine is required.
1) Remove clean out cap from drainpipe to access blockage;
2) Screw in the clean out adapter 106 to the cleanout of the drainpipe;
3) Attached cleanout adapter 106 to hose 104 via connectors 132 and 134;
4) Connect main body 100 to hose 104 via connectors 128 and 130;
5) Connect main body 100 to the auger machine via the auger machine adapter 102;
6) Feed the auger through the main body 100, hose 104 and cleanout adapter 106, and into the drainpipe;
7) Connect a water supply hose to the water supply hose attachment 118;
8) Insert the camera 114 into the camera access to 120, and install the split washer 122 and cap 124;
9) Slide the oil applicator 112 into the inlet aperture 154 until the cable of the auger enters the auger Hall 142 of the oil applicator 112;
10) Install oil canister 108 onto the oil inlet 126 and ensure that the valve is in the closed position;
11) Add oil into the oil canister 108 and attach the oil canister lid 110;
12) Turn on the auger machine and clear the blockage in the drain;
13) Turn on the water supply to flush any remaining and loosened blockage down the drain;
14) Feed the camera 114 down the drain to inspect the drain and any remaining blockage which may be present;
15) Withdraw camera 114 back towards the main body 100. During this withdrawal of the camera 114, the camera 114 and its cable is rinsed by the water provided by the water supply hose attachment 118;
16) Turn on the valve for the oil canister 108;
17) Reverse the auger back into the auger machine. During this withdrawal of the auger, water from the water supply hose attachment 118 rinses the auger cable, the oil applicator 112 physically removes material that has not been rinsed off, and the oil applicator 112 oils that cleaned cable as it returns to the auger machine;

Once the auger has been fully retracted, the water supply can be turned off, the valve for the oil canister 108 can be turned off and the parts of the sleeve are disassembled and packaged up for the next use where the above-noted steps can be repeated again.

By using the sleeve of the aforementioned embodiments, there are many advantages that are attained. Because the auger and the cable are fully enclosed between the auger machine and the drainpipe, splatter and damage is prevented in the working area. Cleanup of the working environment and of the equipment is also faster, which results in a quicker turnaround time for the operator. This then results in fewer customer complaints as less time is spent and there is minimum dirtying of the working environment. By using the extension hoses, the operator is not restricted to working in cramped places. Furthermore, the operator is shielded from the splatter that typically arises when the auger is retracted from the drain when the sleeve is not used. From a safety perspective, the operator is protected from injury due to binding and slapping of the auger and coil as the operator will not be in contact with the auger and cable during operation of the auger machine.

Additional advantages of the sleeve of the aforementioned embodiments is the integration of the camera and water pressure supply with the auger, which can operate at the same time. Both the camera and the auger and cable are rinsed by the water pressure as they are each retracted back out of the drainpipe. The oil applicator both removes any materials not rinsed by the water and oils that cleaned cable. Furthermore, the water pressure being applied also serves to loosen and flush any blockage debris down the drain.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

1. An apparatus to unclog drains, said apparatus comprises:
an auger;
a coiled flexible cable adapted to connect to said auger:
a rigid main body defining an interior portion and having an upstream end adapted to receive the auger and the coiled cable, and having a downstream end for passing the auger and the coiled cable;
a flexible sleeve defining an interior portion and having a first end and a second end to receive and pass the auger and the coiled cable, the first end being configured for leak proof attachment to the downstream end of the rigid main body, and the second end comprising a leak proof attachment adapted to securely attach to a drain access port.

2. The apparatus according to claim 1, further comprising a fluid injection port located on the main body and adapted to permit fluid injection into the main body and towards the downstream end; the fluid injection port adapted to allow injection of fluid when in use and to seal against fluid leakage when not in use.

3. The apparatus according to claim 1, wherein the auger is connected to a manual auger feed.

4. The apparatus according to claim 1, wherein the auger is connected to an electric auger self-feeding machine.

5. The apparatus according to claim 1, further comprising an access port on the main body to allow a cabled inspection camera to be introduced into the main body and the sleeve.

6. The apparatus according to claim 2, further comprising a valve located proximate the fluid injection port, the valve adapted to control the volume of fluid being injected into the main body.

7. The apparatus according to claim 1, wherein the upstream end of the main body is configured for connection with a manual auger or electric auger self-feeding machine.

8. The apparatus according to claim 1, wherein the main body includes an oil inlet located upstream of the fluid injection port, said oil inlet configured to receive an oil applicator for contacting the coiled cable.

9. The apparatus according to claim 8, wherein the oil inlet includes a raised circular sidewall extending from the main body, and the apparatus further includes an oil canister for storing oil, the oil canister having a neck with an aperture configured to rotate within the raised circular sidewall to release stored oil onto the oil inlet and the oil applicator when the aperture overlaps the oil inlet.

10. An apparatus for use with a coiled cable for unclogging a drain, comprising:
a rigid main body defining an interior portion and having an upstream end adapted to receive an auger connected to the coiled cable, and having a downstream end for passing the auger and the coiled cable;
a flexible sleeve defining an interior portion and having a first end and a second end to receive and pass the auger and the coiled cable; the first end being configured for leak proof attachment to the downstream end of the main body, and the second end comprising a leak proof attachment adapted to securely attach to a drain access port;

11. The apparatus according to claim 10, further comprising a fluid injection port located on the main body and adapted to permit fluid injection into the main body towards the downstream end; the fluid injection port adapted to allow injection of fluid when in use and to seal against fluid leakage when not in use.

12. The apparatus according to claim 10, further comprising an access port on the main body to allow a cabled inspection camera to be introduced into the main body and the sleeve.

13. The apparatus according to claim 11, further comprising a valve located proximate the fluid injection port, the valve adapted to control the volume of fluid being injected into the main body.

14. The apparatus according to claim 10, wherein the upstream end of the main body is configured for connection with a manual auger or electric auger self feeding machine.

15. The apparatus according to claim 10, wherein the main body includes an oil inlet located upstream of the fluid injection port, said oil inlet configured to receive an oil applicator for contacting the coiled cable.

16. The apparatus according to claim 15, wherein the oil inlet includes a raised circular sidewall extending from the main body, and the apparatus further includes an oil canister for storing oil, the oil canister having a neck with an aperture configured to rotate within the raised circular sidewall to release stored oil onto the oil inlet and the oil applicator when the aperture overlaps the oil inlet.
